(19) United States
(12) Patent Application Publication
(10) Pub. No.: US 2024/0127776 A1
(43) Pub. Date: Apr. 18, 2024

(54) DYNAMIC CONTROL OF GENERATIVE MUSIC COMPOSITION

(71) Applicant: Aimi Inc., Littleton, CO (US)

(72) Inventors: Edward Balassanian, Austin, TX (US); Toby Gifford, Melbourne (AU); Branislav Simo Cirkovic, Irvine, CA (US)

(21) Appl. No.: 18/486,256

(22) Filed: Oct. 13, 2023

Related U.S. Application Data
(60) Provisional application No. 63/379,462, filed on Oct. 14, 2022.

(51) Int. Cl. G10H 1/00

(52) U.S. Cl. CPC G10H 1/0025; G10H 2210/111

(57) ABSTRACT

Techniques are disclosed relating to adjusting, via a user interface, parameters (e.g., the gain) of musical phrases in generative music content. A computing system may select a set of musical phrases to include in generative music content. The computing system may determine respective gain values of multiple selected musical phrases. The computing system may mix the selected musical phrases based on the determined gain values to generate output music content. The computing system may cause display of an interface that visually indicates the selected musical phrases and their determined gain values relative to other selected musical phrases. The computing system may receive user gain input that indicates to adjust a gain value of one of the selected musical phrases. The computing system may adjust the mix of the selected musical phrases based on the user input.

The present application claims priority to U.S. Provisional App. No. 63/379,462, entitled “Dynamic Control of Generative Music Composition,” filed Oct. 14, 2022, the disclosure of which is incorporated by reference herein in its entirety.

### BACKGROUND

### Technical Field

This disclosure relates to audio engineering and more particularly to computer-composed music content.

### Description of the Related Art

Generative music systems may use computer systems to compose music content. For example, the AiMi platform allows users to select a genre of music and listen to dynamically-generated compositions in that genre. Users may also provide feedback regarding compositions and the system may adjust composition parameters based on user feedback.

In the context of generative music, it may be challenging to convey aspects of the composition to users or to determine fine-grained preferences of a given user.

### BRIEF DESCRIPTION OF THE DRAWINGS

FIG. 1 is a diagram illustrating an exemplary music generator module that generates music content based on multiple different types of inputs, according to some embodiments.

FIG. 2 is a diagram illustrating an example interface that shows multiple mixed musical phrases, according to some embodiments.

FIG. 3 is diagram illustrating example user resizing of a displayed musical phrase, according to some embodiments.

FIG. 4 is a diagram illustrating example user musical phrase feedback and an isolated listening function for a musical phrase, according to some embodiments.

FIG. 5 is a diagram illustrating example user phrase feedback, according to some embodiments.

FIG. 6 is a diagram illustrating example user section feedback, according to some embodiments.

FIG. 7A-10B are screenshots illustrating example interfaces, according to some embodiments.

FIG. 11A is a block diagram illustrating an example interface displaying currently-mixed musical phrases in a generative music section.

FIG. 11B is a diagram illustrating an example interface for changing various properties of a selected musical phrase in a generative music section, according to some embodiments.

FIG. 11C is a diagram illustrating an example interface for playing a selected musical phrase in a generative music section, according to some embodiments.

FIG. 12 is a flow diagram illustrating an example method, according to some embodiments.

### DETAILED DESCRIPTION

Generally, generative music being generated “on the fly” may be more difficult to allow users to control, relative to music content that is already recorded and present in a library. Typical generative music software generates its music in real time and does not provide user-accessible options to provide feedback as the music is being generated, with traditional user interfaces not being particularly effective for user customization of generative music. On the other hand, music players for music statically present in a library provide various features that allow rating and evaluating music, but these features are not necessarily available (or even applicable) for dynamically created generative music.

Disclosed systems may implement various techniques to immediately incorporate and reflect user feedback for generative music. User interfaces discussed below may allow the user graphically view internal engine composition decisions (e.g., musical phrase selection, mixing decisions, attributes, parameters, etc.), modify the outcome of these decisions, and send feedback to the system which is reflected in the composition. In some cases, this feedback adjusts the decisions in real-time and may be used for composition on the fly. As discussed in detail below, disclosed user interface techniques may thus simultaneously provide users a view of what is currently happening in a generative music composition and provide users with the ability to impact subsequent composition.

### Overview of Example Music Generator

Generally speaking, a disclosed music generator includes loop data, metadata (e.g., information describing the loops), and a grammar for combining loops based on the metadata. The generator may create music experiences using rules to identify the loops based on metadata and target characteristics of the music experience. It may be configured to expand the set of experiences it can create by adding or modifying rules, loops, and/or metadata. The adjustments may be performed manually (e.g., artists adding new metadata) or the music generator may augment the rules/loops/metadata as it monitors the music experience within the given environment and goals/characteristics desired. For example, if the music generator watches a crowd and sees that people are smiling it can augment its rules and/or metadata to note that certain loop combinations cause people to smile. Similarly, if cash register sales increase, the rule generator can use that feedback to augment the rules/metadata for the associated loops that are correlated with the increase in sales.

As used herein, the term “loop” refers to sound information for a single instrument over a particular time interval. Loops may be played in a repeated manner (e.g., a 30 second loop may be played four times in a row to generate 2 minutes of music content), but loops may also be played once, e.g., without being repeated. Various techniques discussed with reference to loops may also be performed using audio files that include multiple instruments. The term “track” encompasses loops as well as audio files that include sounds from multiple instruments. Further, a “track” may be recorded or may be a computer-generated musical phrase (e.g., completely synthesized from scratch or generated by combining previously-recorded or previously-generated sounds). Generally, the term “musical phrase” refers to information that specifies a sequence of sounds over a time interval. A musical phrase may be a loop or a track and may include a single instrument or multiple instruments. It is to be understood that various techniques discussed with reference to one of loops, track, or musical phrase may be applied to all or any of the three in various embodiments.

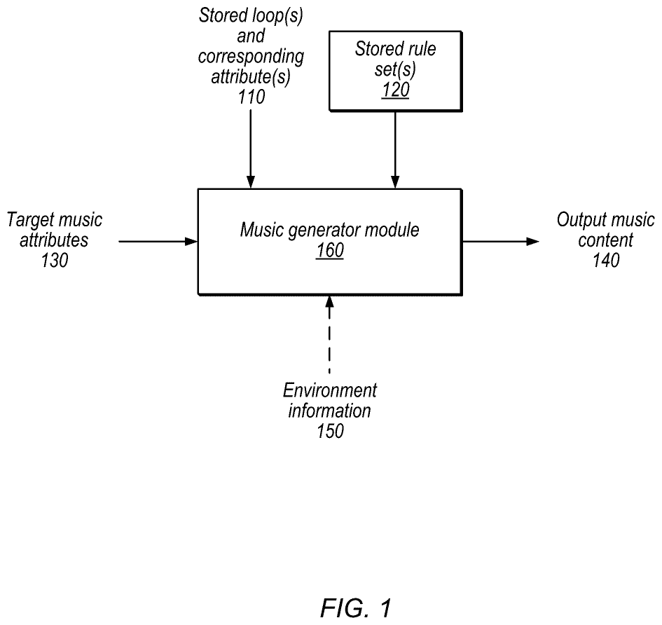

FIG. 1 is a diagram illustrating an exemplary music generator, according to some embodiments. In the illustrated embodiment, music generator module 160 receives various information from multiple different sources and generates output music content 140.

In the illustrated embodiment, module 160 accesses stored loop(s) and corresponding attribute(s) 110 for the stored loop(s) and combines the loops to generate output music content 140. In particular, music generator module 160 selects loops based on their attributes and combines loops based on target music attributes 130 and/or environment information 150. In some embodiments, environment information is used indirectly to determine target music attributes 130. In some embodiments, target music attributes 130 are explicitly specified by a user, e.g., by specifying a desired energy level, mood, multiple parameters, etc. Examples of target music attributes 130 include energy, complexity, and variety, for example, although more specific attributes (e.g., corresponding to the attributes of the stored tracks) may also be specified. The musical attributes may be input by a user or may be determined based on environment information such as ambient noise, lighting, etc. Speaking generally, when higher-level target music attributes are specified, lower-level specific music attributes may be determined by the system before generating output music content. Example techniques for generating music content based on one or more musical attributes are described in more detail in U.S. patent application Ser. No. 13/969,372, filed Aug. 16, 2013 (now U.S. Pat. No. 8,812,144) and titled entitled “Music Generator,” which is incorporated by reference herein in its entirety. The '372 disclosure discusses techniques such as selecting stored loops and/or tracks or generating new loops/tracks, and layering selected loops/tracks to generate output music content. To the extent that any interpretation is made based on a perceived conflict between definitions of any of the incorporated applications and the remainder of the present disclosure, the present disclosure is intended to govern.

Complexity may refer to a number of loops and/or instruments that are included in a composition. Energy may be related to the other attributes or may be orthogonal to the other attributes. For example, changing keys or tempo may affect energy. However, for a given tempo and key, energy may be changed by adjusting instrument types (e.g., by adding hi-hats or white noise), complexity, volume, etc. Variety may refer to an amount of change in generated music over time. Variety may be generated for a static set of other musical attributes (e.g., by selecting different tracks for a given tempo and key) or may be generated by changing musical attributes over time (e.g., by changing tempos and keys more often when greater variety is desired). In some embodiments, the target music attributes may be thought of as existing in a multi-dimensional space and music generator module 160 may slowly move through that space, e.g., with course corrections, if needed, based on environmental changes and/or user input.

In some embodiments, the attributes stored with the loops contain information about one or more loops including: tempo, volume, energy, variety, spectrum, envelope, modulation, periodicity, rise and decay time, noise, artist, instrument, theme, gain, etc. Note that, in some embodiments, loops are partitioned such that a set of one or more loops is specific to a particular loop type (e.g., one instrument or one type of instrument).

In the illustrated embodiment, module 160 accesses stored rule set(s) 120. Stored rule set(s) 120, in some embodiments, specify rules for how many loops to overlay such that they are played at the same time (which may correspond to the complexity of the output music), which major/minor key progressions to use when transitioning between loops or musical phrases, which instruments to be used together (e.g., instruments with an affinity for one another), etc. to achieve the target music attributes. Said another way, the music generator module 160 uses stored rule set(s) 120 to achieve one or more declarative goals defined by the target music attributes (and/or target environment information). In some embodiments, music generator module 160 includes one or more pseudo-random number generators configured to introduce pseudo-randomness to avoid repetitive output music.

Environment information 150, in some embodiments, includes one or more of: lighting information, ambient noise, user information (facial expressions, body posture, activity level, movement, skin temperature, performance of certain activities, clothing types, etc.), temperature information, purchase activity in an area, time of day, day of the week, time of year, number of people present, weather status, etc. In some embodiments, music generator module 160 does not receive/process environment information. In some embodiments, environment information 150 is received by another module that determines target music attributes 130 based on the environment information. Target music attributes 130 may also be derived based on other types of content, e.g., video data. In some embodiments, environment information is used to adjust one or more stored rule set(s) 120, e.g., to achieve one or more environment goals. Similarly, the music generator may use environment information to adjust stored attributes for one or more loops, e.g., to indicate target musical attributes or target audience characteristics for which those loops are particularly relevant.

As used herein, the term “module” refers to circuitry configured to perform specified operations or to physical non-transitory computer readable media that store information (e.g., program instructions) that instructs other circuitry (e.g., a processor) to perform specified operations. Modules may be implemented in multiple ways, including as a hardwired circuit or as a memory having program instructions stored therein that are executable by one or more processors to perform the operations. A hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

As used herein, the phrase “music content” refers both to music itself (the audible representation of music), as well as to information usable to play music. Thus, a song recorded as a file on a storage medium (such as, without limitation a compact disc, flash drive, etc.) is an example of music content; the sounds produced by outputting this recorded file or other electronic representation (e.g., through speakers) is also an example of music content.

The term “music” includes its well-understood meaning, including sounds generated by musical instruments as well as vocal sounds. Thus, music includes, for example, instrumental performances or recordings, a cappella performances or recordings, and performances or recordings that include both instruments and voice. One of ordinary skill in the art would recognize that “music” does not encompass all vocal recordings. Works that do not include musical attributes such as rhythm or rhyme—for example, speeches, newscasts, and audiobooks—are not music.

One piece of music “content” can be distinguished from another piece of music content in any suitable fashion. For example, a digital file corresponding to a first song may represent a first piece of music content, while a digital file corresponding to a second song may represent a second piece of music content. The phrase “music content” can also be used to distinguish particular intervals within a given musical work, such that different portions of the same song can be considered different pieces of musical content. Similarly, different tracks (e.g., piano track, guitar track) within a given musical work may also correspond to different pieces of musical content. In the context of a potentially endless stream of generated music, the phrase “music content” can be used to refer to some portion of the stream (e.g., a few measures or a few minutes).

Music content generated by embodiments of the present disclosure may be “new music content”—combinations of musical elements that have never been previously generated. A related (but more expansive) concept—“original music content”—is described further below. To facilitate the explanation of this term, the concept of a “controlling entity” relative to an instance of music content generation is described. Unlike the phrase “original music content,” the phrase “new music content” does not refer to the concept of a controlling entity. Accordingly, new music content refers to music content that has never before been generated by any entity or computer system.

Conceptually, the present disclosure refers to some “entity” as controlling a particular instance of computer-generated music content. Such an entity owns any legal rights (e.g., copyright) that might correspond to the computer-generated content (to the extent that any such rights may actually exist). In one embodiment, an individual that creates (e.g., codes various software routines) a computer-implemented music generator or operates (e.g., supplies inputs to) a particular instance of computer-implemented music generation will be the controlling entity. In other embodiments, a computer-implemented music generator may be created by a legal entity (e.g., a corporation or other business organization), such as in the form of a software product, computer system, or computing device. In some instances, such a computer-implemented music generator may be deployed to many clients. Depending on the terms of a license associated with the distribution of this music generator, the controlling entity may be the creator, the distributor, or the clients in various instances. If there are no such explicit legal agreements, the controlling entity for a computer-implemented music generator is the entity facilitating (e.g., supplying inputs to and thereby operating) a particular instance of computer generation of music content.

Within the meaning of the present disclosure, computer generation of “original music content” by a controlling entity refers to 1) a combination of musical elements that has never been generated before, either by the controlling entity or anyone else, and 2) a combination of musical elements that has been generated before, but was generated in the first instance by the controlling entity. Content type 1) is referred to herein as “novel music content,” and is similar to the definition of “new music content,” except that the definition of “novel music content” refers to the concept of a “controlling entity,” while the definition of “new music content” does not. Content type 2), on the other hand, is referred to herein as “proprietary music content.” Note that the term “proprietary” in this context does not refer to any implied legal rights in the content (although such rights may exist), but is merely used to indicate that the music content was originally generated by the controlling entity. Accordingly, a controlling entity “re-generating” music content that was previously and originally generated by the controlling entity constitutes “generation of original music content” within the present disclosure. “Non-original music content” with respect to a particular controlling entity is music content that is not “original music content” for that controlling entity.

Some pieces of music content may include musical components from one or more other pieces of music content. Creating music content in this manner is referred to as “sampling” music content, and is common in certain musical works, and particularly in certain musical genres. Such music content is referred to herein as “music content with sampled components,” “derivative music content,” or using other similar terms. In contrast, music content that does not include sampled components is referred to herein as “music content without sampled components,” “non-derivative music content,” or using other similar terms.

In applying these terms, it is noted that if any particular music content is reduced to a sufficient level of granularity, an argument could be made that this music content is derivative (meaning, in effect, that all music content is derivative). The terms “derivative” and “non-derivative” are not used in this sense in the present disclosure. With regard to the computer generation of music content, such computer generation is said to be derivative (and result in derivative music content) if the computer generation selects portions of components from pre-existing music content of an entity other than the controlling entity (e.g., the computer program selects a particular portion of an audio file of a popular artist's work for inclusion in a piece of music content being generated). On the other hand, computer generation of music content is said to be non-derivative (and result in non-derivative music content) if the computer generation does not utilize such components of such pre-existing content. Note some pieces of “original music content” may be derivative music content, while some pieces may be non-derivative music content.

It is noted that the term “derivative” is intended to have a broader meaning within the present disclosure than the term “derivative work” that is used in U.S. copyright law. For example, derivative music content may or may not be a derivative work under U.S. copyright law. The term “derivative” in the present disclosure is not intended to convey a negative connotation; it is merely used to connote whether a particular piece of music content “borrows” portions of content from another work.

Further, the phrases “new music content,” “novel music content,” and “original music content” are not intended to encompass music content that is only trivially different from a pre-existing combination of musical elements. For example, merely changing a few notes of a pre-existing musical work does not result in new, novel, or original music content, as those phrases are used in the present disclosure. Similarly, merely changing a key or tempo or adjusting a relative strength of frequencies (e.g., using an equalizer interface) of a pre-existing musical work does not produce new, novel, or original music content. Moreover, the phrases, new, novel, and original music content are not intended to cover those pieces of music content that are borderline cases between original and non-original content; instead, these terms are intended to cover pieces of music content that are unquestionably and demonstrably original, including music content that would be eligible for copyright protection to the controlling entity (referred to herein as “protectable” music content). Further, as used herein, the term “available” music content refers to music content that does not violate copyrights of any entities other than the controlling entity. New and/or original music content is often protectable and available. This may be advantageous in preventing copying of music content and/or paying royalties for music content.

Although various embodiments discussed herein use rule-based engines, various other types of computer-implemented algorithms may be used for any of the computer learning and/or music generation techniques discussed herein. Rules-based techniques may or may not include statistical and machine learning techniques. Example techniques for generating music content using statistical rules and a machine learning engine are described in more detail in U.S. patent application Ser. No. 16/420,456, filed May 23, 2019 (now U.S. Pat. No. 10,679,596) and titled “Music Generator,” incorporated by reference herein in its entirety. Further example techniques for machine learning training and processing audio data are described in U.S. patent application Ser. No. 17/174,052, filed Feb. 11, 2021 and titled “Music Content Generation Using Image Representations of Audio Files,” incorporated by reference herein in its entirety.

Example User Interface with Bubble Elements

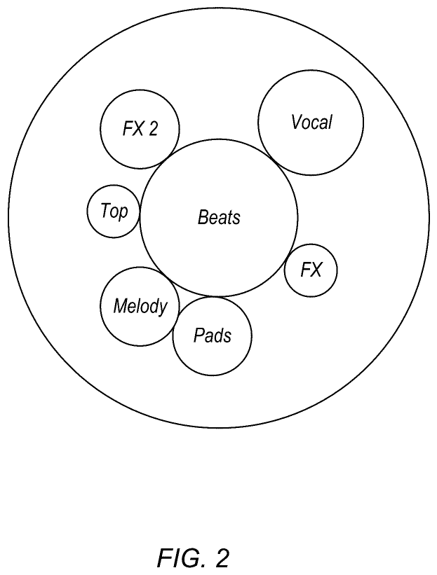

FIG. 2 is a diagram illustrating an example user interface for a generative music application, according to some embodiments. In the illustrated example, the interface includes a circular bubble corresponding to a current section of generative music, which in turn includes multiple smaller bubbles that indicate musical phrases currently being mixed. In this example, the musical phrases include beats, vocal, effects (FX), effects 2, top, melody, and pads.

As a composition plays, tracks may be removed from the mix or inserted into the mix and tracks' volumes may be dynamically adjusted. In some embodiments, the illustrated interface elements reflect composition changes in real time, e.g., by adding/removing bubbles, changing the sizes of bubbles to reflect the current volume of a given track, etc. This may quickly provide detailed information about the current composition state to a user.

As discussed in detail below, users may also interact with the interface to adjust subsequent composition. User-initiated changes may begin to occur immediately in the current composition or may be delayed for certain types of input (e.g., in order to incorporate the changes while continuously playing pleasing music content). For example, a change to the volume of a musical phrase may be reflected immediately in the mix while feedback about a given musical phrase or musical section may be reflected in later composition decisions (e.g., by adjusting the number of times that the musical phrase is included, the amount of time it is played, etc.).

While circular bubbles are discussed herein for purposes of explanation, various other shapes may be displayed in other embodiments, including without limitation: ovals, ellipses, polygons, three-dimensional shapes, etc.

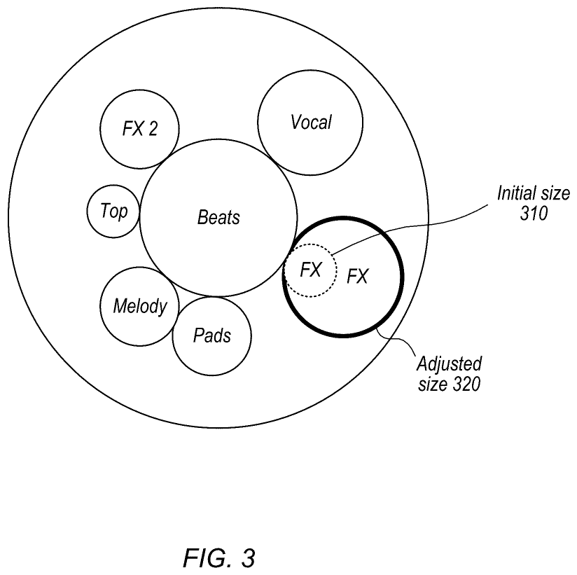

FIG. 3 is a diagram illustrating example user adjustment of a bubble size, according to some embodiments. In the illustrated example, a user selects the FX bubble (with the dotted lines 310 indicating its initial position) and inputs a change in size of the bubble (e.g., by dragging a finger on a touch screen or moving a cursor using a mouse), where the resized FX bubble is shown using a bold line 320. In some embodiments, this immediately increases the volume of the FX musical phrase in the output mix.

Note that the example input of FIG. 3 may also affect future compositions, e.g., the music engine may mix that musical phrase (or similar musical phrases) using a greater volume in subsequent mixes than would have been used prior to the user feedback. Further, while the example input of FIG. 3 may have an immediate effect, the music engine may dynamically adjust the volume of the adjusted musical phrase shortly thereafter (although the adjustment may be scaled based on the user input). Thus, the user's specified volume may not be a static change, but may generally affect the composition in a desired direction.

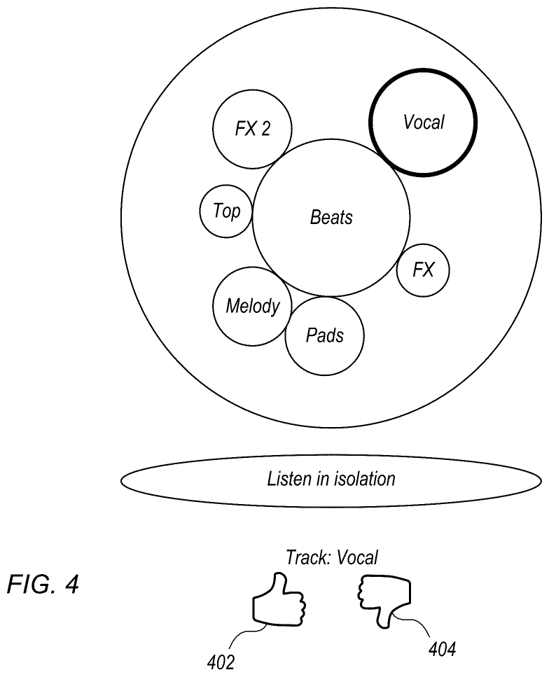

FIG. 4 is a diagram illustrating example interface elements for a particular musical phrase or channel, according to some embodiments. In the illustrated example, the user has selected the vocal musical phrase. The interface provides a “listen in isolation” element that is selectable to play that musical phrase without the other musical phrases being mixed. This allows the user to determine whether the selected musical phrase is really the musical phrase that they want to adjust.

The interface also provides thumbs up and thumbs down elements 402 and 404 that allow a user to provide feedback regarding the musical phrase. Thumbs up may indicate positive feedback while thumbs down may indicate negative feedback. The music engine may use this feedback to adjust parameters relating to future mixing of that musical phrase, e.g., to include it more or less frequently, for shorter or longer time intervals when included, at lesser or greater volumes, more or less often in combination with other musical phrases that were also being mixed at the same time, more or less often in combination with other environmental information for the user at the time the feedback was provided, etc. Note that up and down thumbs are included as one example, but various other feedback interfaces (e.g., a star rating method, a number scale, arrow up/down, like/dislike, etc.) may be implemented to allow a user to provide a rating or otherwise respond to a given musical phrase. In some embodiments, a user pressing thumbs up/down elements 402 and 404 modifies the user's profile information, e.g., to indicate their musical preferences for use in later compositions.

Thus, in some embodiments, feedback relating to musical phrases (or feedback relating to loops/phrases used to build musical phrases) is used to adjust future musical phrase selection. For example, in some embodiments the system is configured to encode musical phrases into vectors and user feedback may be used to select musical phrases with similar vectors to the current musical phrase more or less often. For example, the system may search in a vector space to find similar sounding loops in response to a “thumbs up” for future inclusion. Similarly, the system may reduce the likelihood of playing loops (or prevent inclusion of loops altogether) within a specified distance, in the vector space, from the loop currently being played.

A computing system may create vectors using a self-supervised neural network (which may also be referred to as “unsupervised” that is trained to produce vectors such that the Euclidean distance between vectors corresponds to the audio similarity of the musical phrases. The system may generate training musical phrases or loops by applying various audio transformations to existing musical phrases, such as rate shifting, adding noise and reverb, etc. The training may reward the model for producing vectors such that greater transformation of sounds (when generating the training musical phrases) produce more varied vectors from the neural network. The training may also reward the model for producing vectors such that variations between vectors of modified musical phrases (generated by modifying the same original musical phrases are smaller than variations between vectors for distinct unmodified musical phrases. The training may also reward the system for successfully being able to classify the instrument type, which may encourage clustering of musical phrases in vector space by instrument.

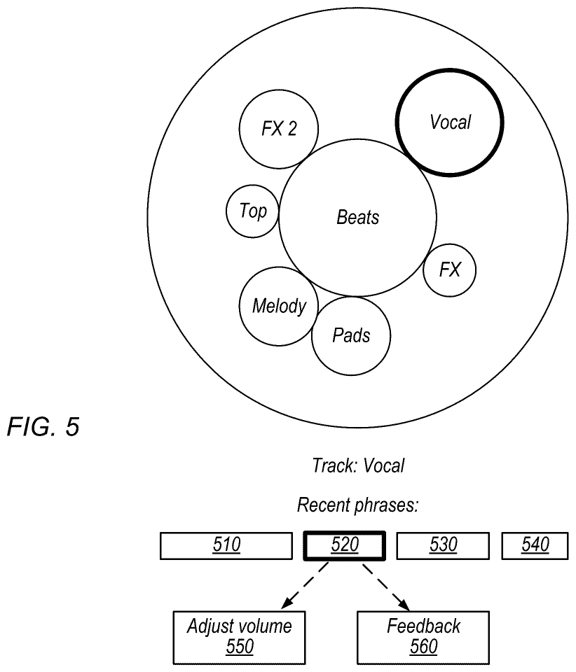

FIG. 5 is a diagram illustrating example phrase-level interaction, according to some embodiments. In the illustrated example, a user has selected the vocal track and the illustrated interface includes elements for four recent phrases of this track 510, 520, 530, and 540. These phrases may be temporal sections of the track (which may be loops). The selected phrase may be played in isolation for the user and the user may adjust the volume via element 550 or provide other feedback via element 560 (e.g., thumbs up or down, a rating, etc. as discussed above). Adjusting the volume may affect the selected phrase relative to the overall volume of the track (which may remain the same or similar for other phrases of the track). Providing feedback may affect parameters for inclusion of the phrase in future mixes (e.g., the likelihood of inclusion, number of times looped if included, adjustments to the phrase for inclusion, etc.).

Note that this interface may display various information about the selected phrase, such as a graph of amplitude over time, frequency information, tempo, key, number of times looped, etc.

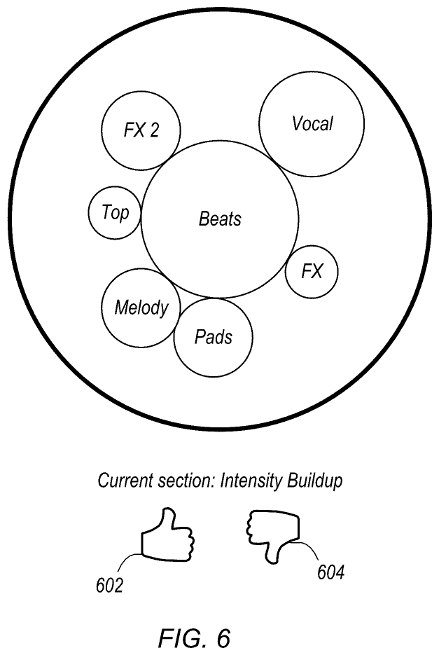

FIG. 6 is a diagram illustrating example mix-level interaction, according to some embodiments. In the illustrated example, a user selects the outer bubble corresponding to the entire mix. The interface shows the current section being composed (“intensity buildup,” in this example). The interface also provides thumbs up and thumbs down elements 602 and 604 for the user to provide feedback on the current section (although various feedback interfaces may be implemented). User feedback on the composition section may be used to adjust parameters for inclusion of that section, such as number of times it is included, length of play when included, volume when included, inclusion in conjunction with other sections (e.g., based on the previous section to when the user provided feedback), etc.

In some embodiments, the interface is configured to display one or more tracks that are not currently being mixed. These tracks may be denoted using a different color, line type, or other visual differences relative to tracks that are currently being mixed. These tracks may also be displayed with separation from tracks that are being mixed (while tracks that are included in the mix are shown as touching or overlapping bubbles, in some embodiments). Displayed non-mixed tracks may be determined by a composition machine learning engine to be appropriate for the current mix, but may not currently be included due to statistical rules or a threshold on tracks included in a particular type of section currently being played, for example.

A user may select and drag bubbles for these tracks, for example, to include those tracks in the mix. Similarly, a user may listen to tracks that are not currently being mixed in isolation and provide feedback for those tracks, which may be used to control future inclusion of such tracks.

Note that various functionality described herein may be performed client-side (e.g., on a user device), server-side, or both. As one example of split functionality, a client device may perform certain disclosed functionality, such as displaying disclosed interfaces while a server may implement adjustments to composition parameters based on user input.

### Example Interface Screenshots

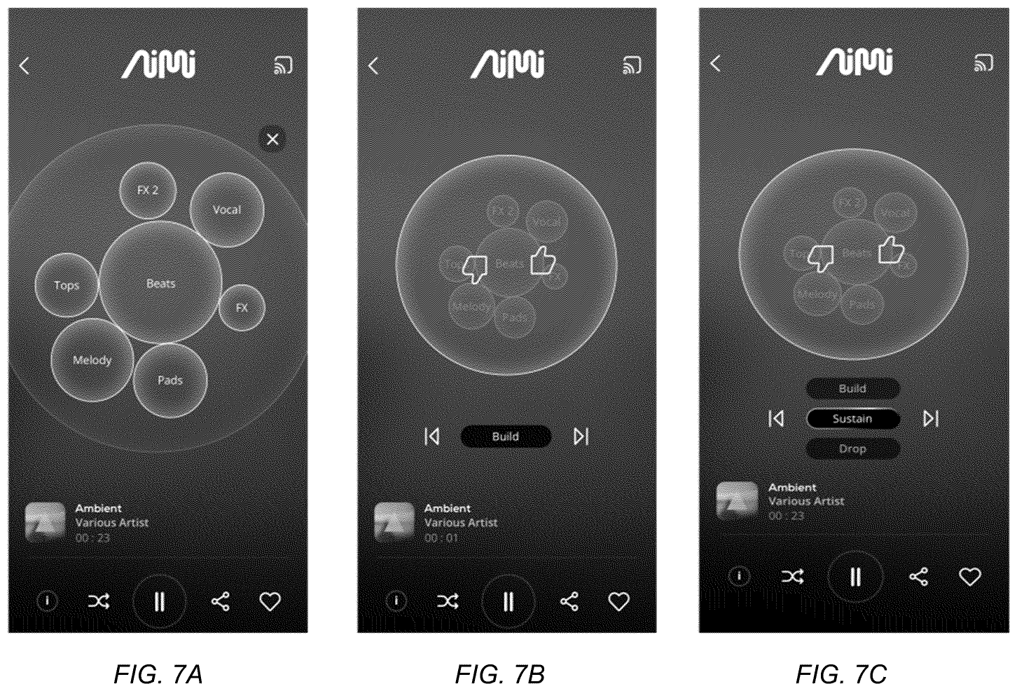

FIGS. 7A-10B are discussed in detail below and show example screenshots from one example generative music application embodiment. In the illustrated examples, a version of the AiMi application displays interface elements relating to example “ambient” and “chill” music experiences.

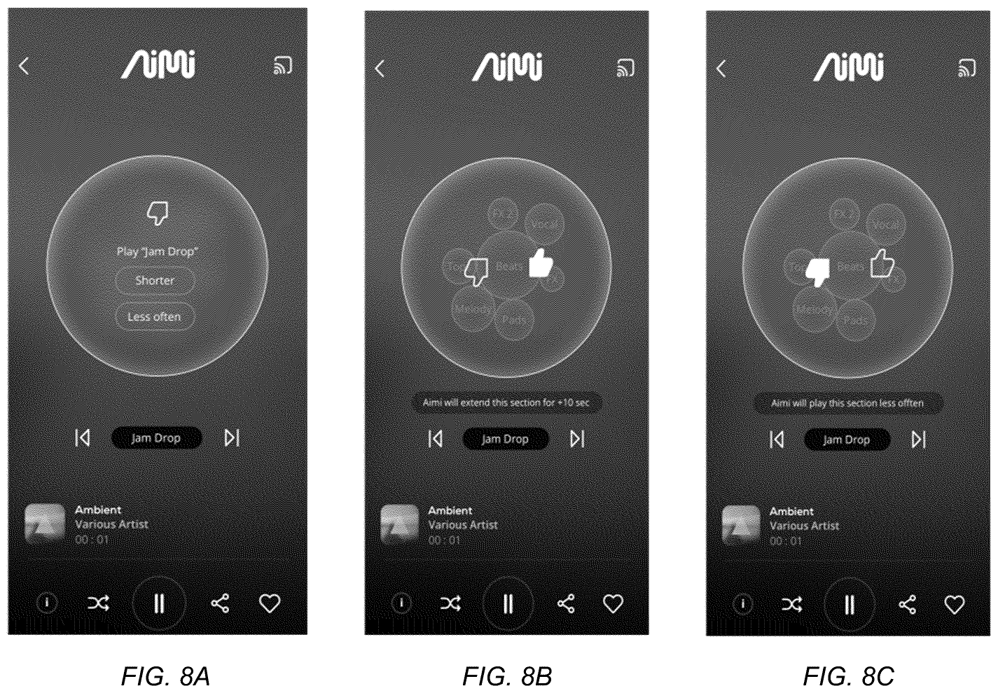

FIG. 7A shows an example interface that shows the tracks currently being mixed. FIG. 7B shows user selection of the overall mix and thumbs up/down elements to receive user input. This interface also shows the current composition section (“build”). FIG. 7B shows user selection of the current composition section (“sustain”) and also shows preceding and following sections (build and drop). In this example, the user can provide feedback on the individual section itself via the thumps up/down interface. FIGS. 8A-8C show example subsequent interfaces after initial user feedback.

In FIG. 8A, the user has selected the thumbs down option for the current section (“Jam Drop”). The interface provides additional elements for more fine-grained feedback. In this example, the user can select to play this composition section for a shorter time interval or less often in future compositions. In FIG. 8B, the interface provides an indication that the Jam Drop section will be extended for an additional 10 seconds. In FIG. 8C, the interface provides an indication that the Jam Drop section will be played less often. Speaking generally, the interface may provide various indications of actions that have been taken based on user feedback regarding a mix, track, section, etc.

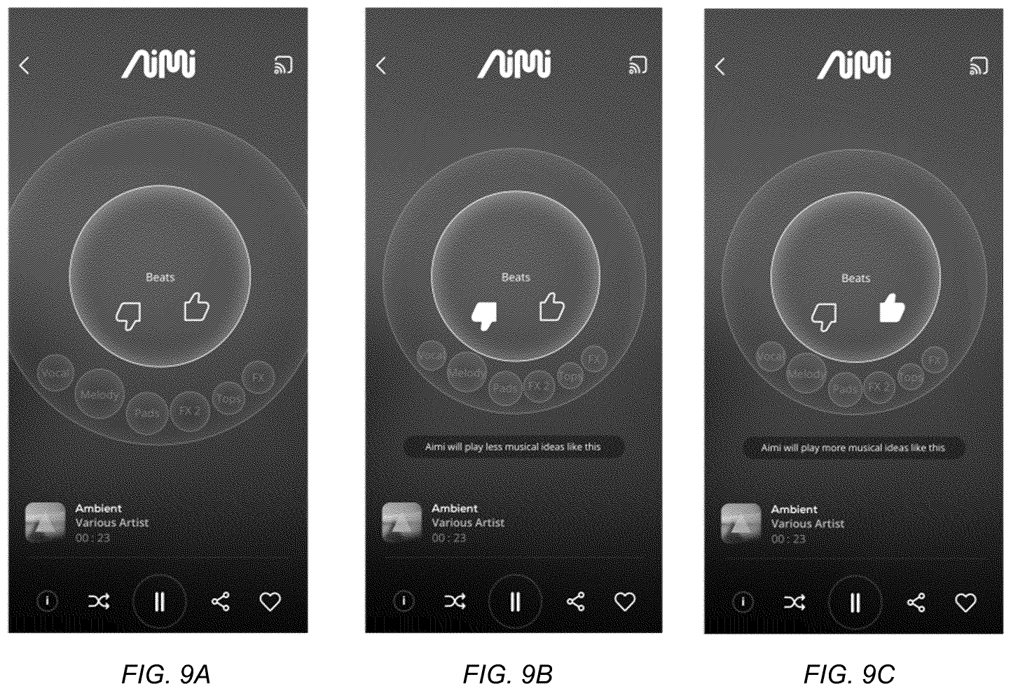

FIG. 9A shows an interface displayed in response to use selection of the beats track. In this example, the beats track and the other tracks are resized and moved relative to FIG. 7A based on user selection of this track. FIG. 9B shows user selection of a thumbs down element for the beats track and an indication that AiMi will play less tracks like this (referred to as musical “ideas” in this interface). FIG. 9C shows user selection of a thumbs up element and an indication that more musical ideas like this will be played in future compositions.

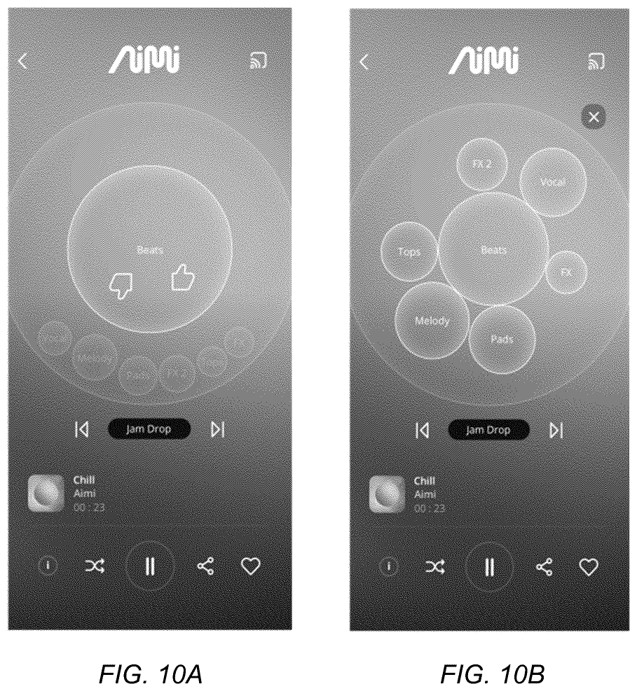

FIGS. 10A and 10B show example interfaces with selections of a beats track and an overall mix, respectively, for a “Chill” composition. As shown, the interface may use different colors to align with different compositions.

Example Interface with More Granular User-Adjustable Parameters

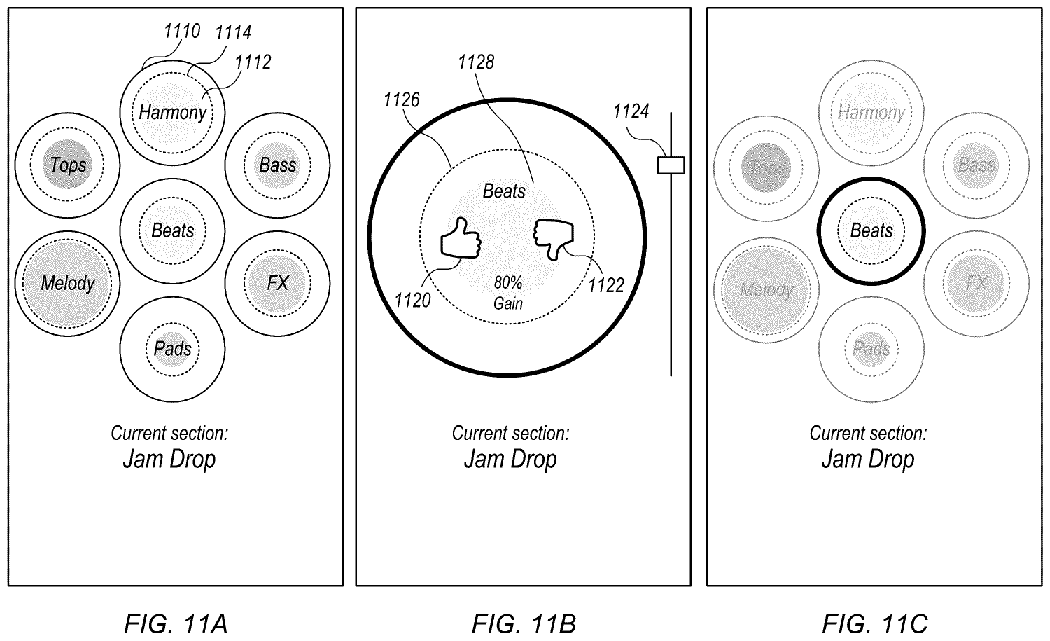

FIGS. 11A-C are discussed in detail below and illustrate example granular track adjustment, according to some embodiments. Note that in these embodiments, each bubble has a fixed size in the illustrated interface, but one or more interior bubbles show the current value of a parameter (e.g., gain), user-indicated value of a parameter (e.g., max gain), or some combination thereof. In other embodiments, inner bubbles may represent multiple different parameters.

Similar to previous examples, a user interface of a generative music application displays tracks of a current section of generative music (in this example, the “Jam Drop” section). In some embodiments, the interface also displays (and potentially allows modification of) the next section to be played. One or more attributes of a particular track (in this example, the gain of the “Beats” track) may be modified using various interface elements.

FIG. 11A is a block diagram illustrating an example interface displaying currently-mixed tracks in a generative music section. As shown, each track (represented by a bubble e.g., circle 1110) includes two concentric circles. In this example, solid circle 1112 reflects the current gain of the track, while dotted circle 1114 reflects the maximum gain of the track (e.g., based on a default maximum or based on prior user input). As will be described with reference to FIG. 11C, a user may define the maximum gain using interface elements. Note that the dotted lines in FIG. 11A differ from those depicted in FIG. 3: FIG. 11C's dotted circles show the maximum gain for a track (and may be actually shown in the user interface), while FIG. 3's dotted circle illustrates an initial volume of its respective track prior to a change (and may not be shown after the change).

FIG. 11B depicts an example interface for changing various properties of a selected track in a generative music section. In particular, FIG. 11B includes thumbs up and down button elements 1120 and 1122, slider 1124, and circles 1126 and 1128. More or fewer interface elements than depicted may be included in the interface of FIG. 11B.

The user may modify the maximum gain of the track (represented by dashed circle 1126). In some embodiments, the user drags slider 1124 (e.g., using a touch screen or a mouse cursor), which updates the maximum gain value (shown at 80%) and the radius of dotted circle 1126. In some embodiments, the maximum gain value is used to limit changes the system may make to the respective track, e.g., when varying gain based on a composition algorithm. The maximum gain value may also limit the impact of other changes by the user (e.g., an adjustment to another parameter may be restricted such that it does not cause the gain of the Beats to exceed the indicated maximum). The user may also use buttons 1120 and 1122 to provide feedback relating to—and potentially modify—the selected track as was described with respect to FIG. 4.

While the maximum gain is the attribute being modified in the depicted figures, other attributes of the track (e.g., current gain, tempo, intensity, effects, syncopation, volume, instrument, etc.) may be analogously modified using similar or different interface elements. For example, a user tapping on slider 1124 may reveal multiple sub-sliders that can each adjust a particular attribute of the track (potentially including gain). Furthermore, interacting with the UI may affect other attributes than those shown in FIG. 11G, such as related attributes in other tracks and/or loops.

In some embodiments (not explicitly shown) a given bubble/circle at one interface level may correspond to a group of tracks or instruments (which may be referred to as channels). In these embodiments, a user may select a group (e.g., by double-tapping) and the interface may show a different level with an expanded view of the channels in that group. A user may then provide independent inputs for the channels. For example, a melody group may include two melody channels. The user may select the melody group and then adjust the gain (or other sub-slider parameters) of one of the melodies.

FIG. 11C depicts an example interface for playing a selected track in a generative music section. As shown, the “Beats” track is selected, causing the system to play only the audio of that track. As shown, this selection causes the other bubbles to become less visible. Additional control buttons (e.g., play, pause, share, or record buttons) may be included in the user interface to control the track being played.

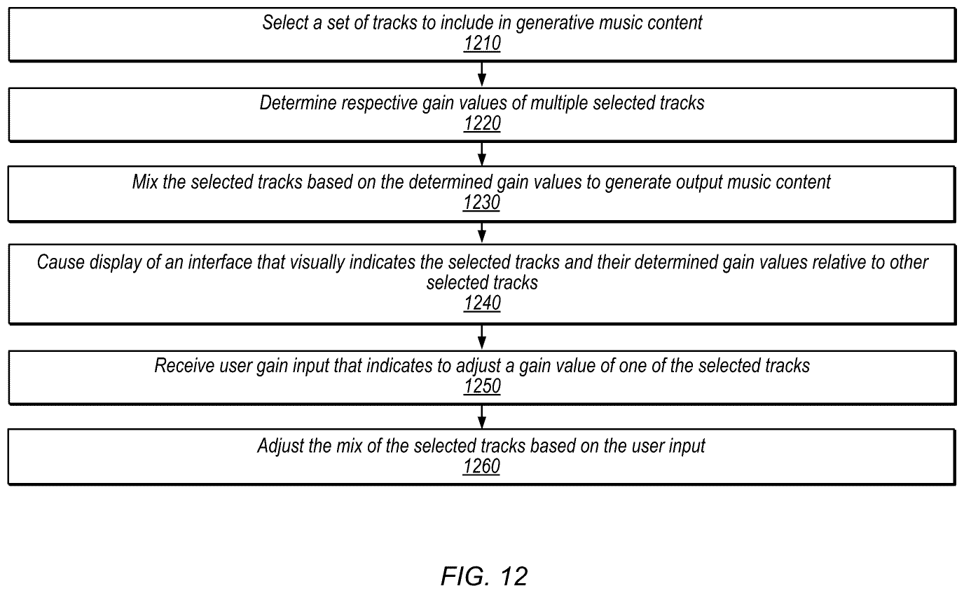

FIG. 12 is a flow diagram illustrating an example method, according to some embodiments. The method shown in FIG. 12 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 1210, in the illustrated embodiment, a computing system selects a set of tracks to include in generative music content.

At 1210, in the illustrated embodiment, the computing system determines respective gain values of multiple selected tracks.

At 1230, in the illustrated embodiment, the computing system mixes the selected tracks based on the determined gain values to generate output music content.

At 1240, in the illustrated embodiment, the computing system causes display of an interface that visually indicates the selected tracks and their determined gain values relative to other selected tracks. In some embodiments, the displayed visual indications of selected tracks include a bubble element per track.

At 1250, in the illustrated embodiment, the computing system receives, via the interface, user gain input that indicates to adjust a gain value of one of the selected tracks. In some embodiments, the user gain input adjusts the size of a displayed visual track indication.

At 1260, in the illustrated embodiment, the computing system adjusts the mix of the selected tracks based on the user input.

In some embodiments, the computing system causes display of an interface option to play the selected track in isolation in response to user input selecting a displayed visual track indication. In some embodiments, the interface further visually indicates, for a given track, both a current gain value of the track and a user-indicated gain level for the track. In some embodiments, the user-indicated gain level is a maximum gain level for the track. In some embodiments, the interface includes, for a user-indicated track, multiple user interface elements (e.g., a group) that are user adjustable to modify one or more additional composition parameters for the user-indicated track. The adjusting of the mix may be further based on one or more modified additional composition parameters for the user-indicated track.

In some embodiments, the computing system, in response to user input selecting a displayed visual track indication, causes display of a feedback interface and receiving user feedback input providing feedback on the selected track, and adjusts parameters for selecting future tracks for mixing based on the user feedback input. The computing system may determine vectors for tracks, where the vectors are generated by an unsupervised machine learning model, and where the adjusting parameters for selecting future tracks includes increasing or decreasing selection of tracks within a threshold distance, in vector space, of the selected track.

In some embodiments, the computing system, in response to user input selecting a displayed visual track indication, causes display of a phrase interface configured to receive user phrase input regarding a phrase included in a track. The computer system may adjust inclusion of a phrase in a future version of the track based on the user phrase input.

In some embodiments, the computing system, in response to user input selecting a displayed mix of tracks, causes display of an indication of a composition section currently being played. The interface may visually indicate one or more additional tracks that are not currently mixed but that are suitable for mixing with the mixed selected tracks. The computing system may, based on user feedback input corresponding to the composition section, adjust one or more parameters for future inclusion of the composition section.

The various techniques described herein may be performed by one or more computer programs. The term “program” is to be construed broadly to cover a sequence of instructions in a programming language that a computing device can execute. These programs may be written in any suitable computer language, including lower-level languages such as assembly and higher-level languages such as Python. The program may written in a compiled language such as C or C++, or an interpreted language such as JavaScript.

Program instructions may be stored on a “computer-readable storage medium” or a “computer-readable medium” in order to facilitate execution of the program instructions by a computer system. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]— is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

“In this disclosure, various “modules” operable to perform designated functions are shown in the figures and described in detail. As used herein, a “module” refers to software or hardware that is operable to perform a specified set of operations. A module may refer to a set of software instructions that are executable by a computer system to perform the set of operations. A module may also refer to hardware that is configured to perform the set of operations. A hardware module may constitute general-purpose hardware as well as a non-transitory computer-readable medium that stores program instructions, or specialized hardware such as a customized ASIC. Accordingly, a module that is described as being “executable” to perform operations refers to a software module, while a module that is described as being “configured” to perform operations refers to a hardware module. A module that is described as “operable” to perform operations refers to a software module, a hardware module, or some combination thereof. Further, for any discussion herein that refers to a module that is “executable” to perform certain operations, it is to be understood that those operations may be implemented, in other embodiments, by a hardware module “configured” to perform the operations, and vice versa.”

What is claimed is:

1. A method, comprising:
selecting, by a computing system, a set of musical phrases to include in generative music content;
determining, by the computing system, respective gain values of multiple selected musical phrases;
mixing, by the computing system, the selected musical phrases based on the determined gain values to generate output music content;
causing display, by the computing system, of an interface that visually indicates the selected musical phrases and their determined gain values relative to other selected musical phrases;
receiving, by the computing system via the interface, user gain input that indicates to adjust a gain value of one of the selected musical phrases; and
adjusting, by the computing system, the mix of the selected musical phrases based on the user input.

2. The method of claim 1, further comprising:
in response to user input selecting a displayed visual musical phrase indication, the computing system causing display of an interface option to play the selected musical phrase in isolation.

3. The method of claim 1, further comprising:
in response to user input selecting a displayed visual musical phrase indication, the computing system causing display of a feedback interface and receiving user feedback input providing feedback on the selected musical phrase; and
adjusting parameters for selecting future musical phrases for mixing based on the user feedback input.

4. The method of claim 3, further comprising:
determining vectors for musical phrases, wherein the vectors are generated by an unsupervised machine learning model;
wherein the adjusting parameters for selecting future musical phrases includes increasing or decreasing selection of musical phrases within a threshold distance, in vector space, of the selected musical phrase.

5. The method of claim 1, further comprising:
in response to user input selecting a displayed visual musical phrase indication, causing display of a phrase interface configured to receive user phrase input regarding a phrase included in a musical phrase.

6. The method of claim 5, further comprising:
adjusting inclusion of a phrase in a future version of the musical phrase based on the user phrase input.

7. The method of claim 1, wherein the user gain input adjusts the size of a displayed visual musical phrase indication.

8. The method of claim 1, wherein the displayed visual indications of selected musical phrases include a bubble element per musical phrase.

9. The method of claim 1, further comprising:
in response to user input selecting a displayed mix of musical phrases, the computing system causing display of an indication of a composition section currently being played.

10. The method of claim 9, further comprising:
based on user feedback input corresponding to the composition section, adjusting one or more parameters for future inclusion of the composition section.

11. The method of claim 9, wherein the interface visually indicates one or more additional musical phrases that are not currently mixed but that are suitable for mixing with the mixed selected musical phrases.

12. The method of claim 1, wherein the interface further visually indicates, for a given musical phrase, both a current gain value of the musical phrase and a user-indicated gain level for the musical phrase.

13. The method of claim 12, wherein the user-indicated gain level is a maximum gain level for the musical phrase.

14. The method of claim 1, wherein:
the interface includes, for a user-indicated musical phrase, multiple user interface elements that are user adjustable to modify one or more additional composition parameters for the user-indicated musical phrase; and
the adjusting is further based on one or more modified additional composition parameters for the user-indicated musical phrase.

15. The method of claim 1, wherein the interface includes a group of the selected musical phrases that is user-selectable to specify user gain inputs for individual musical phrases in the group.

16. An apparatus, comprising:
one or more memories; and
one or more processors configured to execute program instructions stored on the one or more memories to:
select a set of musical phrases to include in generative music content;
determine respective gain values of multiple selected musical phrases;
mix the selected musical phrases based on the determined gain values to generate output music content;
cause display of an interface that visually indicates the selected musical phrases and their determined gain values relative to other selected musical phrases;
receive, via the interface, user gain input that indicates to adjust a gain value of one of the selected musical phrases; and
adjust the mix of the selected musical phrases based on the user input.

17. A non-transitory computer-readable medium having instructions stored thereon that are executable by a computing device to perform operations comprising:
selecting a set of musical phrases to include in generative music content;
determining respective gain values of multiple selected musical phrases;
mixing the selected musical phrases based on the determined gain values to generate output music content;
causing display of an interface that visually indicates the selected musical phrases and their determined gain values relative to other selected musical phrases;
receiving, via the interface, user gain input that indicates to adjust a gain value of one of the selected musical phrases; and
adjusting the mix of the selected musical phrases based on the user input.

18. The non-transitory computer-readable medium of claim 17, wherein the operations further comprise causing display, in response to user input selecting a displayed visual musical phrase indication, of an interface option to play the selected musical phrase in isolation.

19. The non-transitory computer-readable medium of claim 17, wherein the operations further comprise:
causing display, in response to user input selecting a displayed visual musical phrase indication, of a feedback interface and receiving user feedback input providing feedback on the selected musical phrase; and
adjusting parameters for selecting future musical phrases for mixing based on the user feedback input.

20. The non-transitory computer-readable medium of claim 17, wherein the interface further visually indicates, for a given musical phrase, both a current gain value of the musical phrase and a user-indicated gain level for the musical phrase.
